(19) United States
(12) Patent Application Publication
(10) Pub. No.: US 2010/0035608 A1
(43) Pub. Date: Feb. 11, 2010

(54) METHOD AND DEVICE FOR GENERATING SUBSCRIBER INFORMATION

(75) Inventors: Jun ZHU, Shenzhen (CN); Hong TANG, Shenzhen (CN)

Correspondence Address: Leydig, Voit & Mayer, Ltd;(for Huawei Technologies Co., Ltd), Two Prudential Plaza Suite 4900, 180 North Stetson Avenue, Chicago, IL, 60601, US

(73) Assignee: Huawei Technologies Co., Ltd., Shenzhen (CN)

(21) Appl. No.: 12/537,529

(22) Filed: Aug. 7, 2009

Related U.S. Application Data
(63) Continuation of application No. PCT/CN2009/070081, filed on Jan. 8, 2009.

(30) Foreign Application Priority Data
Aug. 11, 2008 (CN) 200810147357.7

(51) Int. Cl. H04W 4/00

(52) U.S. Cl. 455/433

(57) ABSTRACT

The embodiment of the present invention discloses a method and a device for generating subscriber information. The method for generating subscriber information includes: obtaining original subscriber information sent by a home location register (HLR) in a home network to a mobile switching center (MSC) in a visited network of the roaming subscriber; identifying the original subscriber information and generating new subscriber information according to an identification result and prerecorded subscriber subscription service information; and sending the new subscriber information to the MSC in the visited network of the roaming subscriber. The embodiment of the present invention obtains the original subscriber information through signaling monitoring or signaling interception, and then modifies the original subscriber information. Thus, a subscriber can use various services provided by the visited network of the roaming subscriber.

### CROSS-REFERENCE TO RELATED APPLICATIONS

This application is a continuation of International Patent Application No. PCT/CN2009/070081, filed Jan. 8, 2009, which claims priority to Chinese Patent Application No. 200810147357.7, filed Aug. 11, 2008, both of which are hereby incorporated by reference in their entireties.

### FIELD OF THE TECHNOLOGY

The present invention relates to the field of network communication technology, and more particularly to a method and device for generating subscriber information.

### BACKGROUND

Customized Applications for Mobile Network Enhanced Logic (CAMEL) is a dedicated wireless intelligent network standard for Global System for Mobile Communications (GSM) specified by the European Telecommunications Standards Institute (ETSI), and is used to provide intelligent services (for example, CAMEL value-added services) to a subscriber in a GSM network. If a GSM subscriber desires to use a CAMEL service, the GSM subscriber needs to subscribe to the CAMEL service. As a result, CAMEL service-related information, that is, CAMEL subscription information (CSI, i.e., subscriber subscription information), needs to be added into the original subscriber information. The CSI information varies with different CAMEL services applied by the subscriber. The information is respectively stored in a home location register (HLR) and/or a visitor location register (VLR) according to different properties thereof.

The CSI includes originated-CAMEL subscription information (O-CSI), terminated-CAMEL subscription information (T-CSI), supplementary services notification CSI, translation information flag CSI, unstructured supplementary services data (USSD) CSI, USSD general CSI, and the like. Among them, the O-CSI and T-CSI are the most important. Subscribers applying for an originated CAMEL service have the O-CSI, and those applying for a terminated CAMEL service have the T-CSI.

Currently, many operators provide CAMEL services to the roaming subscribers. However, due to the uniqueness of attributes of the CAMEL services, a subscriber can subscribe to one intelligent service. Hence, when the subscriber internationally roams to a new network, it is desired to provide an intelligent service to the subscriber by the new network.

### SUMMARY

Accordingly, the present invention is directed to a method and device for generating subscriber information, which enables a subscriber to use value-added services provided by a visited network of the roaming subscriber by obtaining subscriber information through signaling monitoring or signaling interception and modifying a service attribute of the subscriber information.

In order to achieve the above objective, an embodiment of the present invention provides a method for generating subscriber information, including: (1) obtaining original subscriber information to a mobile switching center (MSC) in a visited network of the roaming subscriber; (2) identifying the original subscriber information, and generating new subscriber information according to an identification result and prerecorded subscriber subscription service information; and (3) sending the new subscriber information to the MSC in the visited network of the roaming subscriber.

The present invention further provides a server, including: (1) an acquisition module, adapted to obtain original subscriber information sent to an MSC in a visited network of the roaming subscriber; (2) an information generation module, adapted to identify the original subscriber information and generate new subscriber information according to an identification result and prerecorded subscriber subscription service information; and (3) a sending module, adapted to send the new subscriber information to the MSC in the visited network of the roaming subscriber.

Compared with the conventional art, the embodiments of the present invention have the following advantages. With the embodiments of the present invention, a service server obtains original subscriber information through signaling monitoring or signaling interception and generates new subscriber information, so that the MSC in the visited network of the roaming subscriber may provide various services of the visited network of the roaming subscriber for the subscriber by using the generated new subscriber information as subscriber information. Technical solutions of the present invention are described in further detail below with reference to the accompanying drawings and embodiments.

### BRIEF DESCRIPTION OF THE DRAWINGS

FIG. 1 is a flow chart of a method for generating subscriber information according to an embodiment of the present invention;

FIG. 2 is a schematic view of a networking structure of a method for generating subscriber information according to Embodiment 1 of the present invention;

FIG. 3 is a flow chart of the method for generating subscriber information according to Embodiment 1 of the present invention;

FIG. 4 is a schematic view of a networking structure of a method for generating subscriber information according to Embodiment 2 of the present invention;

FIG. 5 is a flow chart of the method for generating subscriber information according to Embodiment 2 of the present invention;

FIG. 6 is a flow chart of a method for generating subscriber information according to Embodiment 3 of the present invention;

FIG. 7 is a flow chart of a method for generating subscriber information according to Embodiment 4 of the present invention; and

FIG. 8 is a schematic structural view of a server according to an embodiment of the present invention.

### DETAILED DESCRIPTION

The embodiments of the present invention provide a method and device for generating subscriber information, so as to generate new subscriber information to enable a subscriber to use services provided by a visited network of the roaming subscriber.

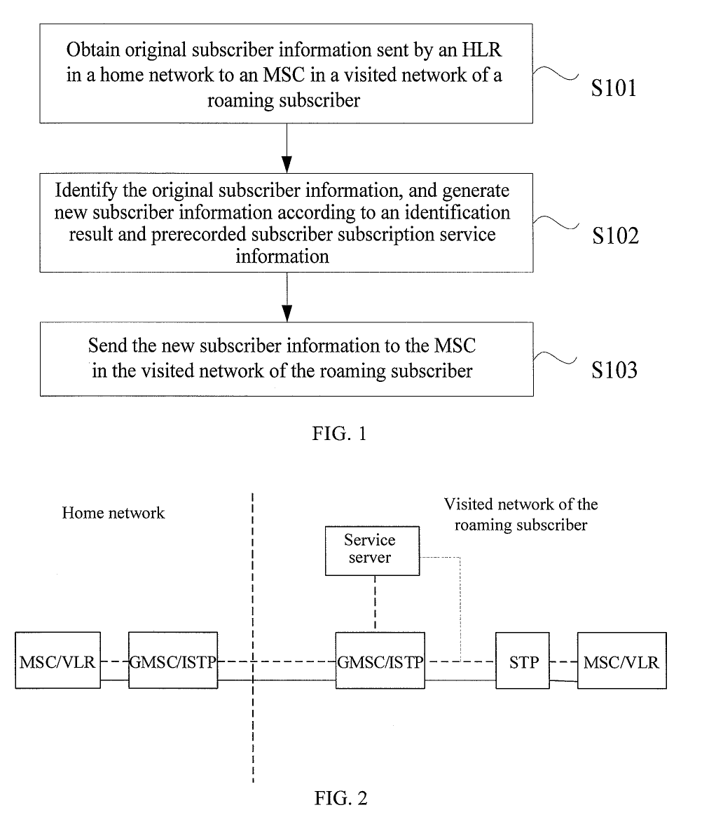

FIG. 1 is a flow chart of a method for generating subscriber information according to an embodiment of the present invention, which specifically includes the following steps.

Step 101: obtaining original subscriber information sent by an HLR in a home network to an MSC in a visited network of the roaming subscriber.

In the embodiment of the present invention, an international service gateway (ISG) is deployed in the visited network of the roaming subscriber to serve as a service server. Before roaming to a visited network of the roaming subscriber from the home network, a subscriber may subscribe to a service of the visited network of the roaming subscriber. The ISG service server platform records subscriber subscription service information. The subscriber subscription service information may include one or more of: value-added service subscription information, one-card-multi-number service information of the subscriber, and other subscription service information. The subscription service information may specifically include one or more of: mobile station Integrated Services Digital Network (MSISDN), a visited network of the roaming subscriber address of the subscriber, a visitor location register (VLR) address, a forwarded to number (FTN), and subscriber subscription attribute CSI. When the subscriber roams to a visited network of the roaming subscriber, the MSC in the visited network of the roaming subscriber sends a location update message to the HLR in the home network of the subscriber, and the HLR in the home network sends the original subscriber information to the MSC in the visited network of the roaming subscriber after receiving the location update message.

The service server obtains the original subscriber information sent by the HLR in the home network to the MSC in the visited network of the roaming subscriber through signaling monitoring or signaling interception. Optionally, the service server may store the obtained original subscriber information.

Step 102: identifying the original subscriber information, and generating new subscriber information according to an identification result and prerecorded subscriber subscription service information.

Specifically, the step may be as follows. If the subscriber subscription service information prerecorded in the service server is value-added service subscription information of the subscriber in the visited network of the roaming subscriber, when the service server identifies that the original subscriber information contains subscriber subscription information, the service server modifies the subscriber subscription information into new subscriber subscription information according to the prerecorded value-added service subscription information of the subscriber in the visited network of the roaming subscriber, and updates the new subscriber subscription information into the original subscriber information to generate the new subscriber information. When the service server identifies that the original subscriber information does not contain the subscriber subscription information, the service server creates subscriber subscription information according to the prerecorded value-added service subscription information of the subscriber in the visited network of the roaming subscriber, and inserts the subscriber subscription information into the original subscriber information to generate the new subscriber information.

If the prerecorded subscriber subscription service information is one-card-multi-number service information of the subscriber, when the service server identifies that the original subscriber information contains a primary subscriber number MSISDN, the service server modifies the primary subscriber number MSISDN into a secondary subscriber number MSISDN′ according to the prerecorded one-card-multi-number service information of the subscriber, and updates the secondary subscriber number MSISDN′ into the original subscriber information to generate the new subscriber information. When the service server identifies that the original subscriber information does not contain the primary subscriber number MSISDN, the service server inserts the secondary subscriber number MSISDN′ into the original subscriber information according to the prerecorded one-card-multi-number service information of the subscriber to generate the new subscriber information.

Step 103: sending the new subscriber information to the MSC in the visited network of the roaming subscriber.

The MSC in the visited network of the roaming subscriber provides a service of the visited network of the roaming subscriber for the subscriber according to the received new subscriber information.

If the service server obtains the original subscriber information sent by the HLR in the home network to the MSC in the visited network of the roaming subscriber through signaling monitoring, in this step, the service server actively simulates the HLR in the home network to send the generated new subscriber information to the MSC in the visited network of the roaming subscriber again.

If the subscriber subscription service information prerecorded in the service server is the value-added service subscription information of the subscriber in the visited network of the roaming subscriber, the MSC in the visited network of the roaming subscriber receives the original subscriber information sent by the HLR to the MSC in the visited network of the roaming subscriber in Step 101. When the original subscriber information received by the MSC in the visited network of the roaming subscriber contains the subscriber subscription information, the MSC in the visited network of the roaming subscriber uses the new subscriber subscription information contained in the new subscriber information that is received again after Step 103 to overwrite the subscriber subscription information in the original subscriber information, and provides a value-added service of the visited network of the roaming subscriber for the subscriber by using the new subscriber subscription information. When the original subscriber information does not contain the subscriber subscription information, the MSC in the visited network of the roaming subscriber provides the value-added service of the visited network of the roaming subscriber for the subscriber by using the new subscriber subscription information that is received again.

If the subscriber subscription service information prerecorded in the service server is the one-card-multi-number service information of the subscriber, the MSC in the visited network of the roaming subscriber receives the original subscriber information sent by the HLR to the MSC in the visited network of the roaming subscriber in Step 101. When the original subscriber information received by the MSC in the visited network of the roaming subscriber contains the primary subscriber number MSISDN, the MSC in the visited network of the roaming subscriber uses the secondary subscriber number MSISDN′ contained in the new subscriber information that is received again after Step 103 to overwrite the primary subscriber number MSISDN in the original subscriber information, and provides a one-card-multi-number service of the visited network of the roaming subscriber for the subscriber by using the secondary subscriber number MSISDN′. When the original subscriber information does not contain the primary subscriber number MSISDN, the visited network of the roaming subscriber provides the one-card-multi-number service of the visited network of the roaming subscriber for the subscriber by using the secondary subscriber number MSISDN′ contained in the new subscriber information that is received again.

If the service server obtains the original subscriber information sent by the HLR in the home network to the MSC in the visited network of the roaming subscriber through signaling interception, in this step, the service server sends the new subscriber information generated in Step 102 to the MSC in the visited network of the roaming subscriber. For example, if the subscriber subscription service information prerecorded in the service server is the value-added service subscription information of the subscriber in the visited network of the roaming subscriber, when the original subscriber information intercepted by the service server contains the subscriber subscription information, the service server modifies the subscriber subscription information into new subscriber subscription information according to the prerecorded value-added service subscription information of the subscriber in the visited network of the roaming subscriber, updates the new subscriber subscription information into the original subscriber information to generate the new subscriber information, and sends the generated new subscriber information to the MSC in the visited network of the roaming subscriber. When the original subscriber information intercepted by the service server does not contain the subscriber subscription information, the service server creates subscriber subscription information according to the prerecorded value-added service subscription information of the subscriber in the visited network of the roaming subscriber, inserts the created subscriber subscription information into the original subscriber information to generate the new subscriber information, and sends the new subscriber information to the MSC in the visited network of the roaming subscriber. As the original subscriber information in Step 101 is intercepted, the MSC in the visited network of the roaming subscriber receives the new subscriber information containing the subscriber subscription information in Step 103. The MSC in the visited network of the roaming subscriber provides a value-added service of the visited network of the roaming subscriber for the subscriber by using the received new subscriber information as the subscriber information. When the service server is faulty, all signaling may be sent through an original international signaling transfer point (ISTP), ensuring that the current network is not affected.

If the subscriber subscription service information prerecorded in the service server is one-card-multi-number service information of the subscriber, when the original subscriber information intercepted by the service server contains the primary subscriber number MSISDN, the service server modifies the primary subscriber number MSISDN into a secondary subscriber number MSISDN′ according to the prerecorded one-card-multi-number service information of the subscriber, updates the secondary subscriber number MSISDN′ into the original subscriber information to generate the new subscriber information, and sends the new subscriber information to the MSC in the visited network of the roaming subscriber. When the original subscriber information intercepted by the service server does not contain the primary subscriber number MSISDN, the service server inserts the secondary subscriber number MSISDN′ into the original subscriber information according to the prerecorded one-card-multi-number service information of the subscriber to generate the new subscriber information, and sends the new subscriber information to the MSC in the visited network of the roaming subscriber. As the original subscriber information in Step 101 is intercepted, the MSC in the visited network of the roaming subscriber receives the new subscriber information containing the secondary subscriber number MSISDN′ in Step 103. The MSC in the visited network of the roaming subscriber provides a one-card-multi-number service of the visited network of the roaming subscriber for the subscriber by using the received new subscriber information as the subscriber information. When the service server is faulty, all signaling may be sent via the original ISTP, ensuring that the current network is not affected.

FIG. 2 is a schematic view of a networking structure of a method for generating subscriber information according to Embodiment 1 of the present invention.

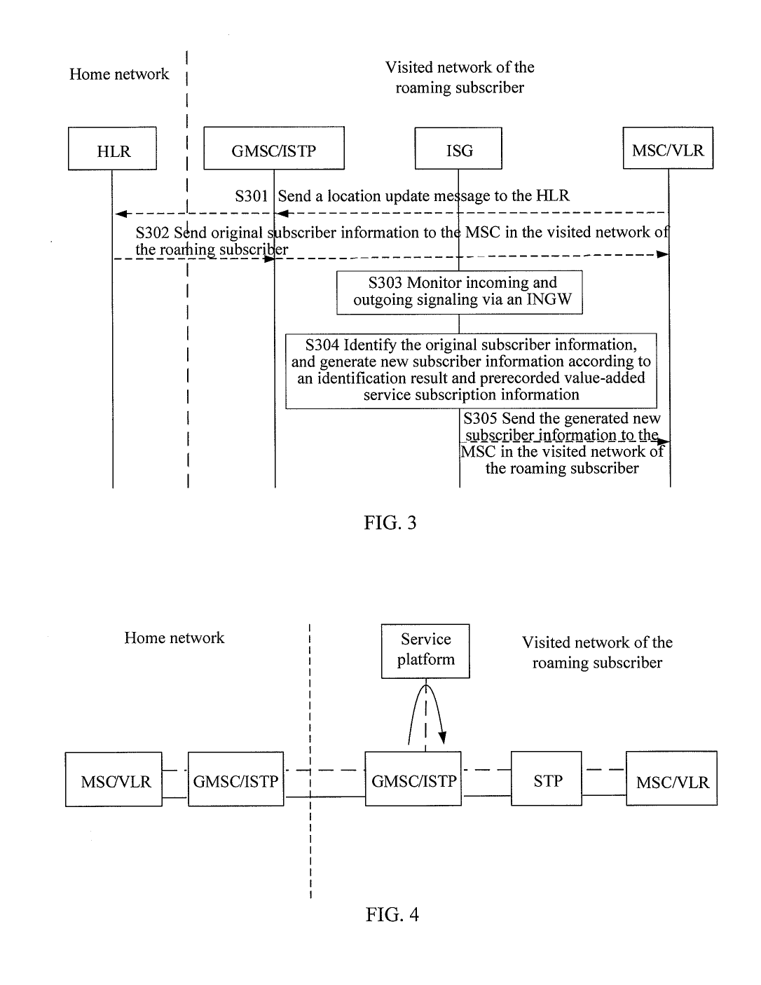

In the embodiment of the present invention, an ISG is deployed in a visited network of the roaming subscriber to serve as a service server, for monitoring all incoming and outgoing signaling via an international gateway (INGW) in the visited network of the roaming subscriber. In the embodiment of the present invention, a subscriber subscribes to a value-added service of the visited network of the roaming subscriber, for example, a service triggered by subscriber information, such as a short number service or an intelligent dialing service, so subscriber subscription service information recorded in the ISG service server is value-added service subscription information of the subscriber in the visited network of the roaming subscriber, and the value-added service subscription information contains subscription-related information of the subscriber in the visited network of the roaming subscriber. FIG. 3 is a flow chart of the method for generating subscriber information according to Embodiment 1 of the present invention, which specifically includes the following steps.

Step 301: When the subscriber internationally roams to a visited network of the roaming subscriber, an MSC in the visited network of the roaming subscriber sends a location update message to an HLR in a home network of the subscriber.

Step 302: The HLR in the home network sends original subscriber information of the subscriber to the MSC in the visited network of the roaming subscriber after receiving the location update message, and the MSC in the visited network of the roaming subscriber receives the original subscriber information.

Step 303: The service server monitors incoming and outgoing signaling via the INGW. In this embodiment, when monitoring the original subscriber information sent by the HLR in the home network to the MSC in the visited network of the roaming subscriber, the service server stores the original subscriber information.

Step 304: identifying the original subscriber information monitored by the service server, and generating new subscriber information according to an identification result and the prerecorded value-added service subscription information.

When the service server identifies that the original subscriber information contains subscriber subscription information, the service server modifies a service attribute of the subscriber subscription information, that is, a subscriber subscription attribute according to the prerecorded value-added service subscription information of the subscriber in the visited network of the roaming subscriber to generate new subscriber subscription information, and updates the generated new subscriber subscription information into the original subscriber information to generate new subscriber information. That is, in this embodiment, the modified subscriber subscription information is used as subscriber subscription information. Specifically, the modification of the subscriber subscription attribute may be modifying a subscription service and modifying an address of an SCP that provides the value-added service.

When the service server identifies that the original subscriber information does not contain the subscriber subscription information, for example, when subscriber information of one type of postpaid subscribers does not contain the subscriber subscription information, the service server creates new subscriber subscription information according to the prerecorded value-added service subscription information of the subscriber in the visited network of the roaming subscriber. The newly created subscriber subscription information is used as subscriber subscription information of this type of subscribers.

Step 305: The service server sends the new subscriber information to the MSC in the visited network of the roaming subscriber.

In this embodiment, as the service server obtains the original subscriber information sent by the HLR in the home network to the MSC in the visited network of the roaming subscriber through signaling monitoring, in this step, the service server actively simulates the HLR in the home network to send the new subscriber information to the MSC in the visited network of the roaming subscriber again. The new subscriber information contains the new subscriber subscription information generated in Step 304.

The MSC in the visited network of the roaming subscriber receives the original subscriber information sent by the HLR to the MSC in the visited network of the roaming subscriber in Step 302 as well as the new subscriber information sent in Step 305. When the original subscriber information received by the MSC in the visited network of the roaming subscriber contains the subscriber subscription information, the MSC in the visited network of the roaming subscriber uses the new subscriber subscription information that is received again to overwrite the subscriber subscription information, and provides the value-added service for the subscriber by using the new subscriber subscription information. When the original subscriber information does not contain the subscriber subscription information, the MSC in the visited network of the roaming subscriber provides the value-added service of the visited network of the roaming subscriber for the subscriber by using the subscriber subscription information that is received again as the subscriber subscription information of this type of subscribers.

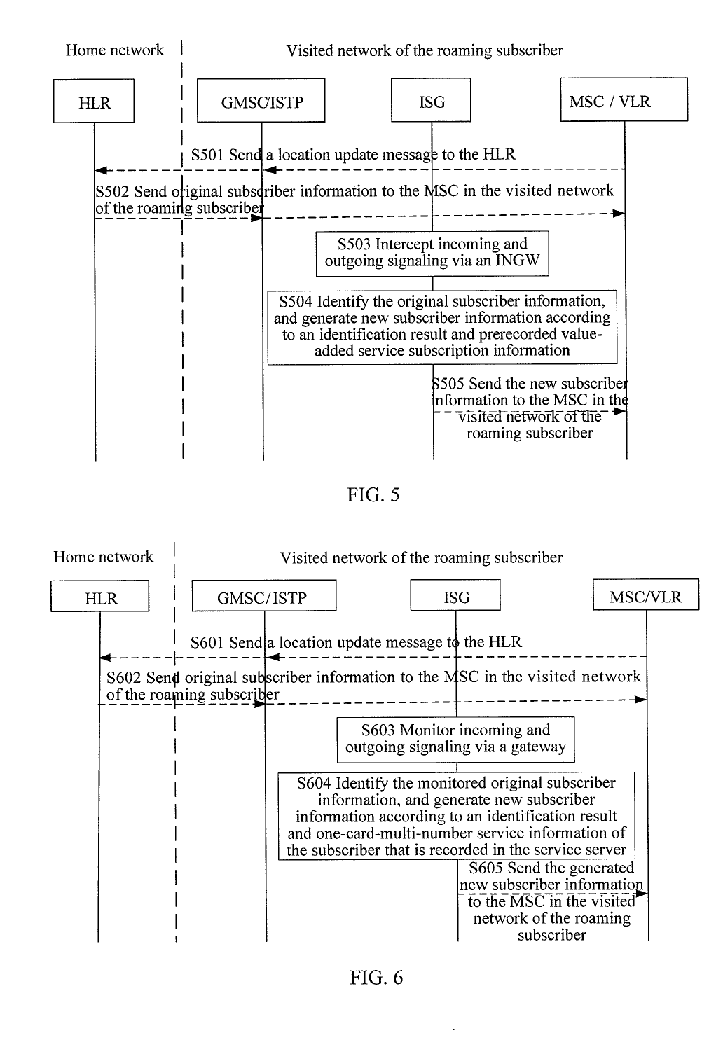

FIG. 4 is a schematic view of a networking structure of a method for generating subscriber information according to Embodiment 2 of the present invention. In the embodiment of the present invention, an ISG is deployed in a visited network of the roaming subscriber to serve as a service server. All signaling passing through an INGW is forwarded to the service server by an ISTP, and is sent to an MSC in the visited network of the roaming subscriber by the service server. In the embodiment of the present invention, a subscriber subscribes to a value-added service of the visited network of the roaming subscriber, so subscriber subscription service information recorded in the ISG service server is value-added service subscription information of the subscriber in the visited network of the roaming subscriber. FIG. 5 is a flow chart of the method for generating subscriber information according to Embodiment 2 of the present invention, which specifically includes the following steps.

Step 501: When the subscriber internationally roams to a visited network of the roaming subscriber, an MSC in the visited network of the roaming subscriber sends a location update message to an HLR in a home network of the subscriber.

Step 502: The HLR in the home network sends original subscriber information to the MSC in the visited network of the roaming subscriber after receiving the location update message.

Step 503: The service server intercepts incoming and outgoing signaling via the gateway. In this embodiment, when intercepting the original subscriber information sent by the HLR in the home network to the MSC in the visited network of the roaming subscriber, the service server stores the original subscriber information.

In the embodiment of the present invention, the original subscriber information is intercepted before the MSC in the visited network of the roaming subscriber receives the original subscriber information sent by the HLR in the home network to the MSC in the visited network of the roaming subscriber.

Step 504: identifying the intercepted original subscriber information, and generating new subscriber information according to an identification result and the prerecorded value-added service subscription information.

When the service server identifies that the original subscriber information contains subscriber subscription information, the service server modifies a service attribute of the subscriber subscription information, that is, a subscriber subscription attribute according to the prerecorded value-added service subscription information of the subscriber in the visited network of the roaming subscriber to generate new subscriber subscription information, and updates the generated new subscriber subscription information into the original subscriber information to generate new subscriber information. That is, in this embodiment, the modified subscriber subscription information is used as subscriber subscription information. Specifically, the modification of the subscriber subscription attribute may be modifying a subscription service key and modifying an address of an SCP that provides the value-added service.

When the service server identifies that the original subscriber information does not contain the subscriber subscription information, for example, when subscriber information of one type of postpaid subscribers does not contain the subscriber subscription information, the service server creates new subscriber subscription information according to the prerecorded value-added service subscription information of the subscriber in the visited network of the roaming subscriber. The newly created subscriber subscription information is used as subscriber subscription information of this type of subscribers.

Step 505: The service server sends the new subscriber information to the MSC in the visited network of the roaming subscriber.

Specifically, this step may be as follows. As the service server intercepts the original subscriber information sent by the HLR in the home network to the MSC in the visited network of the roaming subscriber through signaling interception, in this step, the service server sends the new subscriber information generated in Step 504 to the MSC in the visited network of the roaming subscriber. For example, when the original subscriber information intercepted by the service server contains the subscriber subscription information, the service server modifies the subscriber subscription information into new subscriber subscription information according to the prerecorded value-added service subscription information of the subscriber in the visited network of the roaming subscriber, updates the new subscriber subscription information into the original subscriber information to generate the new subscriber information, and sends the generated new subscriber information to the MSC in the visited network of the roaming subscriber. When the original subscriber information intercepted by the service server does not contain the subscriber subscription information, the service server creates new subscriber subscription information according to the prerecorded value-added service subscription information of the subscriber in the visited network of the roaming subscriber, inserts the created new subscriber subscription information into the original subscriber information to generate new subscriber information, and sends the new subscriber information to the MSC in the visited network of the roaming subscriber. As the original subscriber information in Step 502 is intercepted, the MSC in the visited network of the roaming subscriber receives the new subscriber information sent in Step 505. The MSC in the visited network of the roaming subscriber provides the value-added service of the visited network of the roaming subscriber for the subscriber by using the received new subscriber information as the subscriber information. When the service server is faulty, all signaling may be sent via the original ISTP, ensuring that the current network is not affected.

FIG. 6 is a flow chart of a method for generating subscriber information according to Embodiment 3 of the present invention.

In the embodiment of the present invention, an ISG is deployed in a visited network of the roaming subscriber to serve as a service server, for monitoring all incoming and outgoing signaling via an INGW in the visited network of the roaming subscriber. In the embodiment of the present invention, the service of the visited network of the roaming subscriber subscribed to by a subscriber is a one-card-multi-number service, so subscriber subscription service information recorded in the ISG service server is one-card-multi-number service information of the subscriber. The one-card-multi-number service information includes a primary subscriber number MSISDN, a secondary subscriber number MSISDN′, and an international mobile subscriber identity (IMSI) of the subscriber. Specifically, the method is as follows.

In Step 601, when the subscriber internationally roams to a visited network of the roaming subscriber, an MSC in the visited network of the roaming subscriber sending a location update message to an HLR in a home network of the subscriber.

Step 602: The HLR in the home network sends original subscriber information of the subscriber to the MSC in the visited network of the roaming subscriber after receiving the location update message, and the MSC in the visited network of the roaming subscriber receives the original subscriber information.

Step 603: The service server monitors incoming and outgoing signaling via the gateway. In this embodiment, when monitoring the original subscriber information sent by the HLR in the home network to the MSC in the visited network of the roaming subscriber, the service server stores the original subscriber information.

Step 604: identifying the monitored original subscriber information, and generating new subscriber information according to an identification result and the one-card-multi-number service information of the subscriber that is recorded in the service server.

Specifically, this step may be as follows. When the service server identifies that the original subscriber information contains the primary subscriber number MSISDN, the service server modifies the primary subscriber number MSISDN into a secondary subscriber number MSISDN′ according to the one-card-multi-number service information of the subscriber that is recorded in the service server, and updates the secondary subscriber number MSISDN′ into the original subscriber information to generate the new subscriber information. That is, in this embodiment, the secondary subscriber number MSISDN′ is used as the number of the subscriber in the visited network of the roaming subscriber.

When the service server identifies that the original subscriber information does not contain the primary subscriber number MSISDN, the service server creates a secondary subscriber number MSISDN′ according to the prerecorded one-card-multi-number service information of the subscriber, and inserts the secondary subscriber number MSISDN′ into the original subscriber information to generate the new subscriber information. The newly created secondary subscriber number MSISDN′ is used as the number of this type of subscribers in the visited network of the roaming subscriber.

Step 605: The service server sends the new subscriber information to the MSC in the visited network of the roaming subscriber.

In this embodiment, as the service server obtains the original subscriber information sent by the HLR in the home network to the MSC in the visited network of the roaming subscriber through signaling monitoring, in this step, the service server actively simulates the HLR in the home network to send the new subscriber information to the MSC in the visited network of the roaming subscriber again. The new subscriber information contains the secondary subscriber number MSISDN′ in Step 604.

The MSC in the visited network of the roaming subscriber receives the original subscriber information sent by the HLR to the MSC in the visited network of the roaming subscriber in Step 602 as well as the new subscriber information sent in Step 605. When the original subscriber information received by the MSC in the visited network of the roaming subscriber contains the primary subscriber number MSISDN, the MSC in the visited network of the roaming subscriber uses the secondary subscriber number MSISDN′ that is received again to overwrite the primary subscriber number MSISDN, and provides the one-card-multi-number service of the visited network of the roaming subscriber for the subscriber by using the secondary subscriber number MSISDN′. When the original subscriber information does not contain the primary subscriber number MSISDN, the MSC in the visited network of the roaming subscriber provides the one-card-multi-number service of the visited network of the roaming subscriber for the subscriber by using the secondary subscriber number MSISDN′ that is received again as the number of this type of subscribers in the visited network of the roaming subscriber.

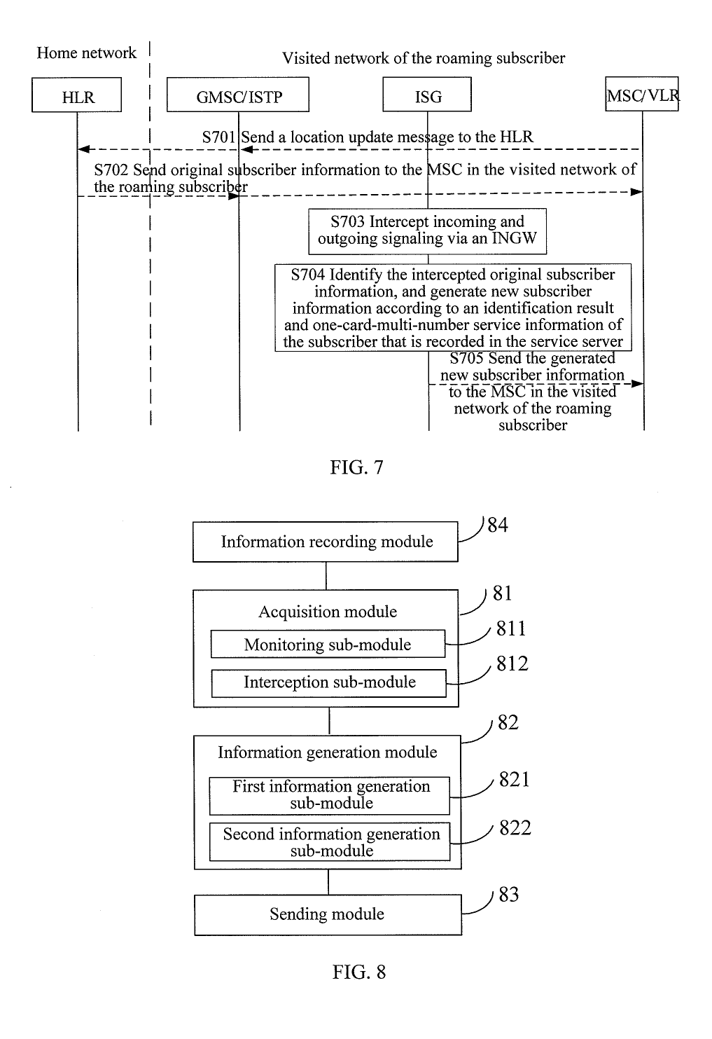

FIG. 7 is a flow chart of a method for generating subscriber information according to Embodiment 4 of the present invention. In the embodiment of the present invention, an ISG is deployed in a visited network of the roaming subscriber to serve as a service server. All signaling passing through an ISG is forwarded to the service server by an ISTP, and is sent to an MSC in the visited network of the roaming subscriber by the service server. In the embodiment of the present invention, a service of the visited network of the roaming subscriber subscribed to by a subscriber is a one-card-multi-number service, so subscriber subscription service information recorded in the ISG service server is one-card-multi-number service information of the visited network of the roaming subscriber. Specifically, the method is as follows.

Step 701: When the subscriber internationally roams to a visited network of the roaming subscriber, an MSC in the visited network of the roaming subscriber sends a location update message to an HLR in a home network of the subscriber.

Step 702: The HLR in the home network sends original subscriber information to the MSC in the visited network of the roaming subscriber after receiving the location update message.

Step 703: The service server intercepts incoming and outgoing signaling via the gateway. In this embodiment, when intercepting the original subscriber information sent by the HLR in the home network to the MSC in the visited network of the roaming subscriber, the service server stores the original subscriber information.

In the embodiment of the present invention, the original subscriber information is intercepted before the MSC in the visited network of the roaming subscriber receives the original subscriber information sent by the HLR in the home network to the MSC in the visited network of the roaming subscriber.

Step 704: identifying the intercepted original subscriber information, and generating new subscriber information according to an identification result and the one-card-multi-number service information of the subscriber that is recorded in the service server.

Specifically, this step may be as follows. When the service server identifies that the original subscriber information contains the primary subscriber number MSISDN, the service server modifies the primary subscriber number MSISDN into a secondary subscriber number MSISDN′ according to the one-card-multi-number service information of the subscriber that is recorded in the service server, and updates the secondary subscriber number MSISDN′ into the original subscriber information to generate the new subscriber information. That is, in this embodiment, the secondary subscriber number MSISDN′ is used as the number of the subscriber in the visited network of the roaming subscriber.

When the service server identifies that the original subscriber information does not contain the primary subscriber number MSISDN, the service server creates a secondary subscriber number MSISDN′ according to the one-card-multi-number service information of the subscriber that is recorded in the service server, and inserts the created secondary subscriber number MSISDN′ into the original subscriber information to generate the new subscriber information. The newly created secondary subscriber number MSISDN′ is used as the number of the subscribers of this kind in the visited network of the roaming subscriber.

Step 705: The service server sends the new subscriber information to the MSC in the visited network of the roaming subscriber.

In the embodiment of the present invention, the service server intercepts the original subscriber information sent by the HLR in the home network to the MSC in the visited network of the roaming subscriber through signaling interception, so in this step, when the original subscriber information intercepted by the service server contains the primary subscriber number MSISDN, the service server modifies the primary subscriber number MSISDN into a secondary subscriber number MSISDN′, updates the secondary subscriber number MSISDN′ into the original subscriber information to generate the new subscriber information, and sends the generated new subscriber information that contains the secondary subscriber number MSISDN′ to the MSC in the visited network of the roaming subscriber. When the original subscriber information intercepted by the service server does not contain the primary subscriber number MSISDN, the service server creates a secondary subscriber number MSISDN′ according to the prerecorded one-card-multi-number service information of the subscriber, inserts the newly created secondary subscriber number MSISDN′ into the intercepted original subscriber information to generate new subscriber information, and sends the new subscriber information that contains the secondary subscriber number MSISDN′ to the MSC in the visited network of the roaming subscriber.

As the original subscriber information in Step 702 is intercepted, the MSC in the visited network of the roaming subscriber receives the new subscriber information containing the secondary subscriber number MSISDN′ that is sent in Step 705. The MSC in the visited network of the roaming subscriber provides the one-card-multi-number service for the subscriber by using the received secondary subscriber number MSISDN′ as a phone number of the subscriber in the visited network of the roaming subscriber. In this embodiment, when the service server is faulty, all signaling may be sent via the original ISTP, ensuring that the current network is not affected.

FIG. 8 is a schematic structural view of a server according to an embodiment of the present invention. The server includes an acquisition module 81, an information generation module 82, and a sending module 83.

The acquisition module 81 is adapted to obtain original subscriber information sent by an HLR in a home network to a mobile switching center (MSC) in a visited network of the roaming subscriber.

The information generation module 82 is adapted to identify the original subscriber information and generate new subscriber information according to an identification result and prerecorded subscriber subscription service information.

The sending module 83 is adapted to send the new subscriber information to the MSC in the visited network of the roaming subscriber.

The server may further include an information recording module 84.

The information recording module 84 is adapted to record the subscriber subscription service information.

The information generation module 82 includes a first information generation sub-module 821 and a second information generation sub-module 822.

The first information generation sub-module 821 is adapted to modify subscriber subscription information into new subscriber subscription information according to prerecorded value-added service subscription information of a subscriber in the visited network of the roaming subscriber when determining that the original subscriber information contains the subscriber subscription information, and update the new subscriber subscription information into the original subscriber information to generate the new subscriber information.

The second information generation sub-module 822 is adapted to create subscriber subscription information according to the prerecorded value-added service subscription information of the subscriber in the visited network of the roaming subscriber when determining that the original subscriber information does not contain the subscriber subscription information, and insert the subscriber subscription information into the original subscriber information to generate the new subscriber information.

Alternatively, the information generation module 82 includes a first information generation sub-module 821 and a second information generation sub-module 822.

The first information generation sub-module 821 is adapted to modify a primary subscriber number MSISDN into a secondary subscriber number MSISDN′ according to prerecorded one-card-multi-number service information of a subscriber when determining that the original subscriber information contains the primary subscriber number MSISDN, and update the secondary subscriber number MSISDN′ into the original subscriber information to generate the new subscriber information.

the second information generation sub-module 822 is adapted to insert the secondary subscriber number MSISDN′ into the original subscriber information according to the prerecorded one-card-multi-number service information of the subscriber when determining that the original subscriber information does not contain the primary subscriber number MSISDN to generate the new subscriber information.

The acquisition module 81 includes a monitoring sub-module 811 and/or an interception sub-module 812.

The monitoring sub-module 811 is adapted to monitor the original subscriber information sent by the HLR in the home network to the MSC in the visited network of the roaming subscriber, and store the original subscriber information when the original subscriber information is monitored.

The interception sub-module 812 is adapted to intercept the original subscriber information sent by the HLR in the home network to the MSC in the visited network of the roaming subscriber, and store the original subscriber information when the original subscriber information is intercepted.

It should be understood by those skilled in the art that the accompanying drawings are merely schematic views of preferred embodiments, and modules or processes in the accompanying drawings are not necessarily required in implementing the present invention.

It should be understood by those skilled in the art that, modules in a device according to an embodiment may be distributed in the device of the embodiment according to the description of the embodiment, or be correspondingly changed to be disposed in one or more devices different from this embodiment. The modules of the above embodiment may be combined into one module, or further divided into a plurality of sub-modules.

The sequence numbers of the above embodiments of the present invention are merely for the convenience of description, and do not imply the preference among the embodiments.

Solutions specified in the claims also fall within the protection scope of the embodiments of the present invention.

Through the above description in the detailed description, it is clear to those skilled in the art that the present invention may be accomplished through hardware, or through software plus necessary universal hardware platform. Base on this, the technical solutions of the present invention may be embodied in the form of a software product. The software product may be stored in one or more nonvolatile storage media (for example, CD-ROM, USB flash drive, or removable hard disk) and contain several instructions adapted to instruct a computer equipment (for example, a personal computer, a server, or a network equipment) to perform the method according to the embodiments of the present invention.

Finally, it should be noted that the above embodiments are merely provided for describing the technical solutions of the present invention, but not intended to limit the present invention. It should be understood by those of ordinary skill in the art that although the present invention has been described in detail with reference to the foregoing embodiments, modifications can be made to the technical solutions described in the foregoing embodiments, or equivalent replacements can be made to some technical features in the technical solutions, as long as such modifications or replacements do not cause the essence of corresponding technical solutions to depart from the scope of the present invention.

What is claimed is:

1. A method for generating subscriber information, comprising:
obtaining original subscriber information sent to a mobile switching center (MSC) in a visited network of a roaming subscriber;
identifying the original subscriber information, and generating new subscriber information according to an identification result and prerecorded subscriber subscription service information; and
sending the new subscriber information to the MSC in the visited network of the roaming subscriber.

2. The method according to claim 1, wherein the prerecorded subscriber subscription service information includes value-added service subscription information of a subscriber in the visited network of the roaming subscriber,
the identifying the original subscriber information and generating the new subscriber information according to the identification result and the prerecorded subscriber subscription service information comprises:
determining that the original subscriber information contains subscriber subscription information,
modifying the subscriber subscription information into the new subscriber subscription information according to the prerecorded value-added service subscription information of the subscriber in the visited network of the roaming subscriber; and
updating the new subscriber subscription information into the original subscriber information to generate the new subscriber information.

3. The method according to claim 2, further comprising:
determining that the original subscriber information does not contain the subscriber subscription information,
creating the subscriber subscription information according to the prerecorded value-added service subscription information of the subscriber in the visited network of the roaming subscriber; and
inserting the subscriber subscription information into the original subscriber information to generate the new subscriber information.

4. The method according to claim 1, wherein the prerecorded subscriber subscription service information includes one-card-multi-number service information of a subscriber,
the identifying the original subscriber information and generating the new subscriber information according to the identification result and the prerecorded subscriber subscription service information comprises:
determining that the original subscriber information contains a primary mobile station Integrated Services Digital Network (MSISDN);
modifying the primary subscriber number MSISDN into a secondary subscriber number MSISDN′ according to the prerecorded one-card-multi-number service information of the subscriber; and
updating the secondary subscriber number MSISDN′ into the original subscriber information to generate the new subscriber information.

5. The method according to claim 4, further comprising:
determining that the original subscriber information does not contain the primary subscriber number MSISDN,
inserting the secondary subscriber number MSISDN′ into the original subscriber information according to the prerecorded one-card-multi-number service information of the subscriber to generate the new subscriber information.

6. The method according to claim 1, wherein the obtaining the original subscriber information sent to the MSC in the visited network of the roaming subscriber comprises:
monitoring the original subscriber information sent to the MSC in the visited network of the roaming subscriber;
storing the monitored original subscriber information.

7. The method according to claim 6, after the sending the new subscriber information to the MSC in the visited network of the roaming subscriber, the method further comprising:
using, by the MSC in the visited network of the roaming subscriber, the received new subscriber information to overwrite the original subscriber information.

8. The method according to claim 1, the obtaining the original subscriber information sent to the MSC in the visited network of the roaming subscriber comprising:
intercepting the original subscriber information sent to the MSC in the visited network of the roaming subscriber; and
storing the intercepted original subscriber information.

9. A server, comprising:
an acquisition module, adapted to obtain original subscriber information sent to a mobile switching center (MSC) in a visited network of a roaming subscriber;
an information generation module, adapted to identify the original subscriber information and generate new subscriber information according to an identification result and prerecorded subscriber subscription service information; and
a sending module, adapted to send the new subscriber information to the MSC in the visited network of the roaming subscriber.

10. The server according to claim 9, further comprising:
an information recording module, adapted to record the subscriber subscription service information.

11. The server according to claim 9, wherein the information generation module comprises:
a first information generation sub-module, adapted to modify subscriber subscription information into new subscriber subscription information according to prerecorded value-added service subscription information of a subscriber in the visited network of the roaming subscriber when determining that the original subscriber information contains the subscriber subscription information, and update the new subscriber subscription information into the original subscriber information to generate the new subscriber information; and
a second information generation sub-module, adapted to create subscriber subscription information according to the prerecorded value-added service subscription information of the subscriber in the visited network of the roaming subscriber when it is identified that the original subscriber information does not contain the subscriber subscription information, and insert the subscriber subscription information into the original subscriber information to generate the new subscriber information.

12. The server according to claim 9, wherein the information generation module comprises:
a first information generation sub-module, adapted to modify a primary mobile station Integrated Services Digital Network (MSISDN) into a secondary subscriber number MSISDN′ according to prerecorded one-card-multi-number service information of a subscriber when determining that the original subscriber information contains the primary subscriber number MSISDN, and update the secondary subscriber number MSISDN′ into the original subscriber information to generate the new subscriber information; and
a second information generation sub-module, adapted to insert the secondary subscriber number MSISDN′ into the original subscriber information according to the prerecorded one-card-multi-number service information of the subscriber when determining that the original subscriber information does not contain the primary subscriber number MSISDN to generate the new subscriber information.

13. The server according to claim 9, wherein the acquisition module comprises at least one of:
a monitoring sub-module, adapted to monitor the original subscriber information sent to the MSC in the visited network of the roaming subscriber, and store the original subscriber information; and
an interception sub-module, adapted to intercept the original subscriber information sent to the MSC in the visited network of the roaming subscriber, and store the original subscriber information.

14. A system for generating subscriber information, comprising:
an MSC in a visited network of a roaming subscriber, adapted to send a location update message to a home location register (HLR) in a home network of the subscriber, and receive a new subscriber information sent by a service server;
the HLR in the home network, adapted to send original subscriber information of the subscriber to the MSC in the visited network of the roaming subscriber; and
the service server, adapted to obtain original subscriber information sent by the HLR in a home network to a mobile switching center (MSC) in the visited network of the roaming subscriber, identify the original subscriber information and generate new subscriber information according to an identification result and prerecorded subscriber subscription service information, and send the new subscriber information to the MSC in the visited network of the roaming subscriber.

15. The system according to claim 14, wherein the service server further adapted to record the subscriber subscription service information.

16. A computer readable medium storing program codes executable by one or more digital processor for generating subscriber information, the program codes comprising:
instructions for obtaining original subscriber information sent to a mobile switching center (MSC) in a visited network of a roaming subscriber;
instructions for identifying the original subscriber information, and generating new subscriber information according to an identification result and prerecorded subscriber subscription service information; and
instructions for sending the new subscriber information to the MSC in the visited network of the roaming subscriber.

17. The computer readable medium according to claim 16, wherein, the program codes further comprises:
instructions for identifying the original subscriber information and generating the new subscriber information according to the identification result and the prerecorded subscriber subscription service information comprises:
instructions for determining that the original subscriber information contains subscriber subscription information,
instructions for modifying the subscriber subscription information into the new subscriber subscription information according to the prerecorded value-added service subscription information of the subscriber in the visited network of the roaming subscriber; and
instructions for updating the new subscriber subscription information into the original subscriber information to generate the new subscriber information.

18. The computer readable medium according to claim 17, wherein, the program codes further comprises:
instructions for determining that the original subscriber information does not contain the subscriber subscription information,
instructions for creating the subscriber subscription information according to the prerecorded value-added service subscription information of the subscriber in the visited network of the roaming subscriber; and
instructions for inserting the subscriber subscription information into the original subscriber information to generate the new subscriber information.
